(19) United States
(12) Patent Application Publication
(10) Pub. No.: US 2025/0048237 A1
(43) Pub. Date: Feb. 6, 2025

(54) METHOD AND APPARATUS FOR HANDLING PEMC SWITCHOVER IN WIRELESS COMMUNICATION SYSTEM

(71) Applicant: Samsung Electronics Co., Ltd., Gyeonggi-do (KR)

(72) Inventors: Arunprasath RAMAMOORTHY, Bangalore (IN); Basavaraj Jayawant PATTAN, Bangalore (IN); Sapan Pramodkumar SHAH, Bangalore (IN)

(21) Appl. No.: 18/844,545

(22) PCT Filed: Apr. 13, 2023
(86) PCT No.: PCT/KR2023/004977

§ 371 Date: Sep. 6, 2024

(30) Foreign Application Priority Data
Apr. 13, 2022 (IN) 202241022236
Mar. 17, 2023 (IN) 202241022236

(51) Int. Cl. H04W 48/16; H04W 4/50; H04W 84/18

(52) U.S. Cl. CPC H04W 48/16; H04W 4/50; H04W 84/18

(57) ABSTRACT

The disclosure relates to a 5G or 6G communication system for supporting a higher data transmission rate. Embodiments herein disclose methods for managing PEMC switchover in PIN by a first PEMC entity. The method includes determining to relinquish a PEMC role associated with the first PEMC entity and transfer the PEMC role to a second PEMC entity upon detecting at least one event. Further, the method includes sending a request message to the second PEMC entity to transfer the PEMC role to the second PEMC entity based on the determination. Further, the method includes receiving an accept message from the second PEMC entity to transfer the PEMC role associated with the first PEMC entity based on the request message. The proposed method provides an efficient management of the personal IoT network with better user experience.

### TECHNICAL FIELD

Embodiments disclosed herein relate to a wireless communication system or network (or a mobile communication network or system), and more particularly related to managing Personal IoT (Internet of Things) Network (PIN) Element with Management Capability (PEMC) switchover in Personal IoT networks.

### BACKGROUND ART

5G mobile communication technologies define broad frequency bands such that high transmission rates and new services are possible, and can be implemented not only in “Sub 6 GHZ” bands such as 3.5 GHz, but also in “Above 6 GHZ” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The principal object of the embodiments herein is to disclose methods and systems (or PIN) for managing Personal IoT Network (PIN) Element with Management Capability (PEMC) handover/transfer in Personal IoT networks (PIN), wherein another PIN element can take over a role of a PEMC.

Another object of the embodiments herein is to disclose methods and systems (or PIN) for managing the PEMC handover/transfer in the Personal IoT networks, wherein existing PIN elements including PEGC which are currently registered into PIN are notified about new PINE taking the role of the PEMC.

Another object of the embodiments herein is to disclose techniques or methods for PEMC replacement triggered internally within the PIN by the PIN element currently assigned with the role of the PEMC.

Another object of the embodiments herein is to disclose techniques for PEMC replacement triggered by a PIN management server.

### Solution to Problem

According to an embodiment of the disclosure, a method performed by a first personal internet of things network (PIN) element with management capability (PEMC) entity which is a PEMC of a PIN is provided. The method comprises: identifying to relinquish a PEMC role based on a condition being satisfied; transmitting, to a second PEMC entity which has a capability for the PEMC of the PIN, a request message to take up the PEMC role; receiving, from the second PEMC entity, a success response message for the request message; and transmitting, to the second PEMC entity, PIN profile information for the PEMC role.

According to an embodiment of the disclosure, a method performed by a second personal internet of things network (PIN) element with management capability (PEMC) entity which has a capability for a PEMC of a PIN is provided. The method comprises: receiving, from a first PEMC entity which is the PEMC of the PIN, a request message to take up a PEMC role, based on a condition being satisfied; transmitting, to the first PEMC entity, a success response message for the request message; and receiving, from the first PEMC entity, PIN profile information for the PEMC role.

According to an embodiment of the disclosure, a first personal internet of things network (PIN) element with management capability (PEMC) entity which is a PEMC of a PIN is provided. The first PEMC entity comprises: a transceiver; and a controller coupled with the transceiver and configured to: identify to relinquish a PEMC role based on a condition being satisfied, transmit, to a second PEMC entity which has a capability for the PEMC of the PIN, a request message to take up the PEMC role, receive, from the second PEMC entity, a success response message for the request message, and transmit, to the second PEMC entity, PIN profile information for the PEMC role.

According to an embodiment of the disclosure, a second personal internet of things network (PIN) element with management capability (PEMC) entity which has a capability for a PEMC of a PIN is provided. The second PEMC entity comprises: a transceiver; and a controller coupled with the transceiver and configured to: receive, from a first PEMC entity which is the PEMC of the PIN, a request message to take up a PEMC role, based on a condition being satisfied, transmit, to the first PEMC entity, a success response message for the request message, and receive, from the first PEMC entity, PIN profile information for the PEMC role.

Accordingly, the embodiments herein provide method for managing Personal IoT Network (PIN) Element with Management Capability (PEMC) switchover in a Personal IoT Network (PIN). The method includes determining, by a first PEMC entity, to relinquish a PEMC role associated with the first PEMC entity and handover (or transfer) the PEMC role to a second PEMC entity upon detecting at least one event. Further, the method includes sending, by the first PEMC entity, a request message to the second PEMC entity to transfer the PEMC role to the second PEMC entity based on the determination. Further, the method includes receiving, by the first PEMC entity, an accept message from the second PEMC entity to transfer the PEMC role associated with the first PEMC entity based on the request message.

In an embodiment, the method includes performing, by the first PEMC entity, at least one of: notifying a PIN management server about the transfer of the PEMC role associated with the first PEMC entity to the second PEMC entity, and releasing the transfer of the PEMC role associated with the first PEMC entity to the second PEMC entity.

In an embodiment, the method includes sending, by the first PEMC entity, at least one of PIN profile information, PIN dynamic information and active profile information of each active PIN element through at least one of a first PEMC entity and a PIN management server.

In an embodiment, sending, by the first PEMC entity, a request message to the second PEMC entity to transfer the PEMC role to the second PEMC entity includes monitoring, by the first PEMC entity, PIN dynamic information associated with a plurality of second PEMC entities, detecting, by the first PEMC entity, that the second PEMC entity from the plurality of second PEMC entities is capable of taking up the PEMC role based on the PIN dynamic information, and sending, by the first PEMC entity, the request message to the second PEMC entity from the plurality of second PEMC entities to transfer the PEMC role to the second PEMC entity.

In an embodiment, at least one event comprises at least one of a power of the first PEMC entity about to drain, a role of the first PEMC entity nearing expiry and a damage to the first PEMC entity.

Accordingly, the embodiments herein provide methods for managing PEMC switchover in a PIN. The method includes detecting, by a PIN management server, at least one event at a first PEMC entity. Further, the method includes sending, by the PIN management server, a request message to a second PEMC entity to transfer a PEMC role to the second PEMC entity upon detecting at least one event at the first PEMC entity. The PEMC role is currently associated with the first PEMC entity. Further, the method includes receiving, by the PIN management server, an accept message from the second PEMC entity to transfer the PEMC role associated with the first PEMC entity based on the request message.

In an embodiment, sending, by the PIN management server, the request message to the second PEMC entity to transfer the PEMC role to the second PEMC entity includes monitoring, by the PIN management server, PIN dynamic information and a PIN profile associated with a plurality of second PEMC entities, detecting, by the PIN management server, that the second PEMC entity from the plurality of second PEMC entities is capable of taking up the PEMC role based on the PIN dynamic information and the PIN profile, and sending, by the PIN management server, the request message to the second PEMC entity from the plurality of second PEMC entities to transfer the PEMC role to the second PEMC entity.

In an embodiment, the request message includes the PIN dynamic information.

In an embodiment, the second PEMC entity notifies all the PINEs in the PIN including a PIN element with Gateway Capability (PEGC) about a change in the PIN element acting as PEMC and its reachability information.

Accordingly, the embodiments herein provide a PEMC entity (aka “PEMC”) including a PEMC controller coupled with a processor and a memory. The PEMC controller is configured to determine to relinquish a PEMC role associated with the first PEMC entity and handover (or transfer) the PEMC role to a second PEMC entity upon detecting at least one event. Further, the PEMC controller is configured to send a request message to the second PEMC entity to transfer the PEMC role to the second PEMC entity based on the determination. Further, the PEMC controller is configured to receive an accept message from the second PEMC entity to transfer the PEMC role associated with the first PEMC entity based on the request message.

Accordingly, the embodiments herein provide a PIN management server including a PEMC controller coupled with a processor and a memory. The PEMC controller is configured to detect at least one event at a first Personal IoT Network (PIN) Element with Management Capability (PEMC) entity. Further, the PEMC controller is configured to send a request message to a second PEMC entity to transfer a PEMC role to the second PEMC entity upon detecting at least one event at the first PEMC entity, wherein the PEMC role is currently associated with the first PEMC entity. Further, the PEMC controller is configured to receive an accept message from the second PEMC entity to transfer the PEMC role associated with the first PEMC entity based on the request message.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

According to various embodiment of the disclosure, PIN related procedures can be efficiently enhanced. Specifically, take over of the PEMC role can be efficiently performed.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 depicts an embodiment of performing PEMC switchover, according to embodiments as disclosed herein;

FIG. 2 depicts another embodiment of performing the PEMC switchover, according to embodiments as disclosed herein;

FIG. 3 depicts another embodiment of performing the PEMC switchover, according to embodiments as disclosed herein;

FIG. 4 depicts another embodiment of performing the PEMC switchover, according to embodiments as disclosed herein;

FIG. 5 depicts another embodiment of performing the PEMC switchover, according to embodiments as disclosed herein;

FIG. 6 depicts another embodiment of performing the PEMC switchover, according to embodiments as disclosed herein;

FIG. 7 shows various hardware components of a PIN management server, according to the embodiments as disclosed herein;

FIG. 8 shows various hardware components of a PEMC entity (or PEMC), according to the embodiments as disclosed herein;

FIG. 9 is a flow chart illustrating a method, implemented by the PEMC entity, for managing the PEMC switchover in the PIN, according to the embodiments as disclosed herein;

FIG. 10 is a flow chart illustrating a method, implemented by the PIN management server, for managing the PEMC switchover in the PIN, according to the embodiments as disclosed herein;

FIG. 11 illustrates a block diagram of a server according to embodiments of the present disclosure; and

FIG. 12 illustrates a block diagram of a network entity according to embodiments of the present disclosure.

### MODE FOR THE INVENTION

Before undertaking the detailed descriptions below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The figures included herein, and the various embodiments used to describe the principles of the present disclosure are by way of illustration only and should not be construed in any way to limit the scope of the disclosure. Further, those skilled in the art will understand that the principles of the present disclosure may be implemented in any suitably arranged wireless communication system.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The terms “first PEMC entity (or first PEMC node)” and “first PEMC” are used interchangeably in the patent disclosure. The terms “second PEMC entity (or second PEMC node)” and “second PEMC” are used interchangeably in the patent disclosure.

Network (i.e., PIN) comprises PIN Elements that communicate using PIN direct connection or direct network connection and is managed locally (using a PIN Element with Management Capability (PEMC)).

The PIN Element with Management Capability is the PIN element that provides a means for an authorised administrator to configure and manage the PIN. The PIN element could have been authorized to act as the PEMC for a certain duration after which it is either removed from the PIN or de-authorized to act as the PEMC. Another PIN element in the PIN takes over the role of PEMC. The PEMC might go down for several reasons like hardware failure, time duration for acting as PEMC is expiring, crash or power drain etc., during the time duration when it acting as the PEMC, and another PIN element need to take over the role of PEMC to avoid service disruption. The term PEMC switchover or handover or replacement or transfer means the process by which a new PIN element is assigned the role of PEMC when the current PIN element acting as PEMC needs to relinquished from its PEMC role for any reasons.

Current solutions do not address the following problems:
1. How can another PIN element take over the role of PEMC and what information is required for it to take the role of PEMC?
2. How the existing PIN elements including PEGC are notified about the new PINE taking the role of PEMC.

It is desired to address the above mentioned disadvantages or other short comings or at least provide a useful alternative.

The embodiments herein achieve methods for managing PEMC switchover in a PIN. The method includes determining, by a first PEMC entity, to relinquish a PEMC role associated with the first PEMC entity and handover the PEMC role to a second PEMC entity upon detecting at least one event. Further, the method includes sending, by the first PEMC entity, a request message to the second PEMC entity to transfer the PEMC role to the second PEMC entity based on the determination. Further, the method includes receiving, by the first PEMC entity, an accept message from the second PEMC entity to transfer the PEMC role associated with the first PEMC entity based on the request message.

The proposed methods can be used to manage the the PEMC handover in the personal IoT networks in which another PIN element can take over the role of the PEMC and how existing PIN elements including PEGC which are currently registered into the PIN are notified about the new PINE taking the role of the PEMC. Once the role assignment succeeds, the PIN server and other PIN elements including PEGC are notified of this role change. Thus, results in efficient management of the personal IoT network and enhance the user experience without any service disruption.

The following abbreviations and terms have been referred to herein in the patent disclosure:
a. 3GPP: 3rd Generation Participation Project
b. IoT: Internet of Things
c. D2D: Device to Device
d. PEGC: PIN Element with Gateway Capability
e. PEMC: PIN Element with Management Capability
f. PIN: Personal IoT Network
g. PIN-E: PIN Element
h. ProSe: Proximity Services
i. QOS: Quality of Service
j. UE: User Equipment

1. PIN (Personal IoT Network): Personal IoT Networks (PINs) provide local con-nectivity between UEs (e.g., smart phone, smart watch, laptop, smart TV or the like) and/or non-3GPP devices (e.g., home Wi-Fi device, a public hotspot device or the like). A Personal IoT Network (PIN) consists of PIN Elements (PINE) that communicate using PIN Direct Connection or direct network connection and is managed locally (using a PIN Element with Management Capability).

2. PINE (PIN Element): PIN Elements are UEs and/or non-3GPP devices which form part of the PIN.

3. PEMC (PIN Element with Management Capability): PIN Element which have the capability to provide means for an authorised administrator to configure and manage the PIN.

4. PEGC (PIN Element with Gateway Capability); PIN Elements with Gateway Capability provide means to PIN elements to register and access 5G network services. It can also help in communication between 2 PIN elements that are not within the range to use direct communication.

5. ProSe: ProSe (Proximity Services) is a D2D (Device-to-Device) technology that allows LTE devices to detect each other and to communicate directly.

6. PIN-ID: Unique identifier associated with a PIN.

Embodiments herein methods and systems (or PIN) for managing Personal IoT Network (PIN) Element with Management Capability (PEMC) handover in the PIN, wherein another PIN element can take over the role of the PEMC. Embodiments herein enable existing PIN elements including PEGC to be notified about the new PINE taking the role of the PEMC. The following dynamic information of the PIN which needs to be conveyed to the new PINE taking up the role of the PEMC:
a) PIN identifier;
b) List of PIN elements currently active, their PIN IDs, services offered by them and their reachability information. Optionally, they can also contain the information whether they have the capability to perform the role of PEMC, PEGC or relay etc.

Reachability information could be a IP address or any other information that can be used to reach a particular PIN element;
c) PIN element ID and the reachability information of the PINE acting as the PEMC;
d) PIN element ID and the reachability information of the PINE acting as PEGC;
c) PIN element ID and the reachability information of the PINE acting as Relay;
f) Services currently offered by the PIN; and
g) List of Guest PIN elements present in the PIN and their reachability information.

The dynamic information or the context information of the PIN can either be provided/pushed by the PIN management server (PIN MS) to the new PEMC or the new PEMC can request to retrieve from the PIN MS after it accepts the role of PEMC. The new PIN element taking the role of PEMC can also retrieve the active profiles of each PIN element from the PIN server. The term active profile means the profile information which is shared by the PIN element while it is registering to the PIN MS.

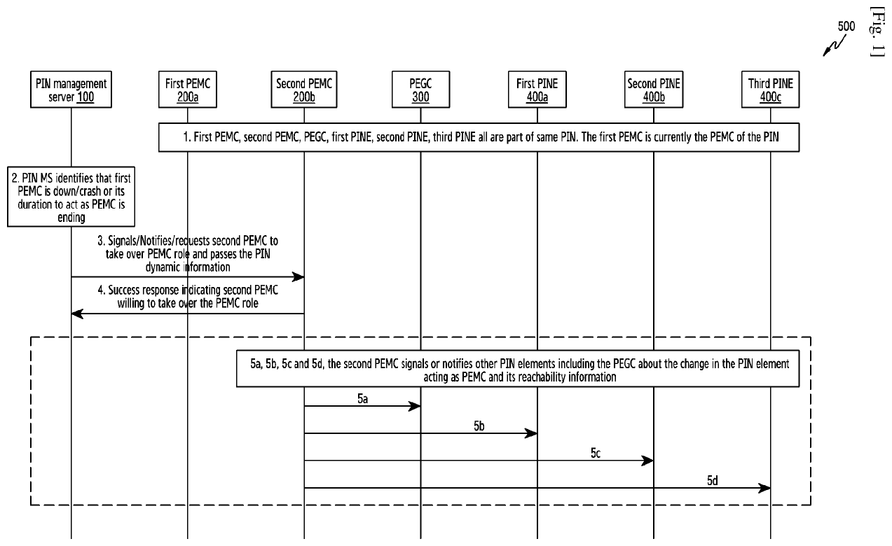

Referring now to the drawings, and more particularly to FIGS. 1 through 10, where similar reference characters denote corresponding features consistently throughout the figures, there are shown at least one embodiment.

FIG. 1 depicts an approach (or step by step operations) for performing PEMC switchover, according to the embodiments as disclosed herein. Consider that the second PEMC PIN element has already requested to act as the PEMC during the registration process but not authorized at that time or it has the capability to take the role of the PEMC. The dynamic information about the PIN (500) is available at the PIN management server (100).

Step 1: a first PEMC (200a), a second PEMC (200b), a PEGC (300), a first PINE (400a), a second PINE (400b), and a third PINE (400c) are part of same PIN (500). The first PEMC (200a) is currently the PEMC of the PIN (500).

Step 2: The PIN MS (100) identifies that the first PEMC (200a) is down/crash or its duration to act as the PEMC is ending.

Step 3: On identifying that the current PEMC down, the PIN MS (100) looks into the PIN profile and PIN dynamic information to identify the new PINE which can take up the role of PEMC PIN element, (in the current example) and signals to the PINE to take over by providing the necessary details about the PIN i.e., PIN dynamic information. In an embodiment, the PINE can fetch the PIN dynamic information from the PIN MS (100) on receiving the signal.

Step 4: If the second PEMC PINE decides to take up the role of PEMC, the second PEMC PINE signals the success response to the PIN MS (100).

Step 5a-Step 5d: Once the takeover/switchover process is a success, the second PEMC (200b) signals all the PINEs in the PIN (500) including the PEGC (300) about the change in the PIN element acting as PEMC and its reachability information.

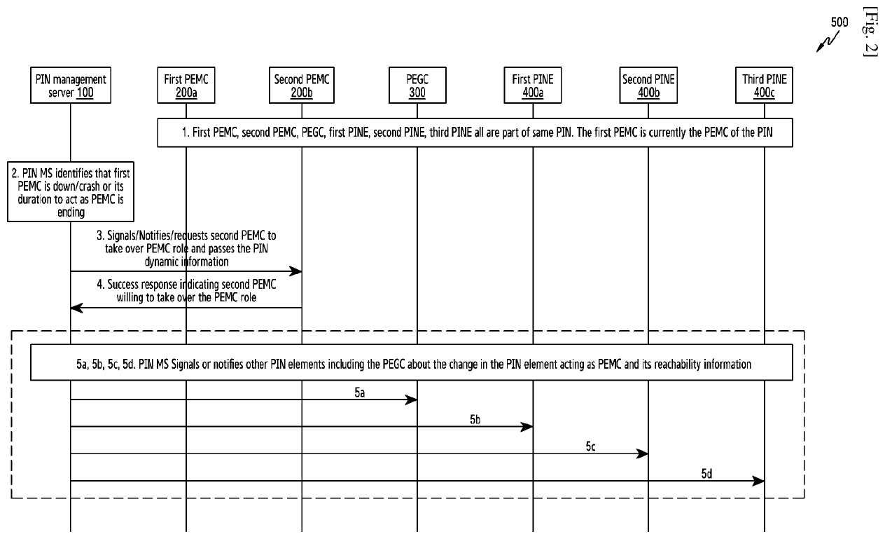

FIG. 2 depicts another approach for performing the PEMC switchover, according to the embodiments as disclosed herein. Consider that the second PEMC PIN element has already requested to act as PEMC during the registration process but not authorized at that time or it can be authorized to take the role of PEMC. The dynamic information about the PIN (500) is available at the PIN management server (100).

Step 1: The first PEMC (200A), the second PEMC (200b), the PEGC (300), the first PINE (400a), the second PINE (400b), and the third PINE (400c) are part of same PIN (500). The first PEMC (200A) is currently the PEMC of the PIN (500).

Step 2: The PIN MS (100) identifies that the first PEMC (200A) is down/crash or its duration to act as the PEMC is ending.

Step 3: On identifying that the current PEMC down, the PIN MS (100) looks into the PIN profile and PIN dynamic information to identify the new PINE which can take up the role of PEMC (second PEMC PIN element, in the current example) and signals to the PINE to take over by providing the necessary details about the PIN i.e., PIN dynamic information. In embodiment, the PINE can fetch the PIN dynamic information from the PIN MS (100) on receiving the signal.

Step 4: If the second PEMC PINE decides to take up the role of PEMC, the second PEMC PINE signals the success response to the PIN MS (100).

Step 5a-Step 5d: Once the takeover/switchover process is a success, the PIN MS (100) signals all the PINEs in the PIN (500) including the PEGC (300) about the change in the PIN element acting as PEMC and its reachability information. The signal to the other PIN elements which are not reachable directly from the PIN MS (100) are sent via the PEGC (300). The PEGC (300) routes the notification signal to the PIN elements inside the PIN.

FIG. 3 depicts another approach for performing the PEMC switchover, according to the embodiments as disclosed herein. Consider that the second PEMC PIN element has already requested to act as the PEMC during the registration process but not authorized at that time or it can be authorized to take the role of PEMC. The dynamic information about the PIN is available at the PIN management server (100) and also at the PEGC (300).

Step 1: the first PEMC (200a), the second PEMC (200b), the PEGC (300), the first PINE (400a), the second PINE (400b), and the third PINE (400c) are part of same PIN (500). The first PEMC (200A) is currently the PEMC of the PIN (500).

Step 2: The PIN MS (100) identifies that the first PEMC (200a) is down/crash or its duration to act as the PEMC is ending.

Step 3: On identifying that the current PEMC down, the PIN MS (100) looks into the PIN profile and PIN dynamic information to identify the new PINE which can take up the role of PEMC (second PEMC PIN element, in the current example) and signals to the PINE to take over by providing the necessary details about the PIN i.e., PIN dynamic information. In an embodiment, the PINE can fetch the PIN dynamic information from the PIN MS (100) on receiving the signal.

Step 4: If the second PEMC PINE decides to take up the role of PEMC, the second PEMC PINE signals the success response to the PIN MS (100).

Step 5: Once the takeover/switchover process is success, the PIN MS (100) signals the PEGC (300) about the change in the PIN element acting as PEMC and its reachability information.

Step 6a-Step 6c: The PEGC (300), on receiving the signal about change in the PEMC (200), will notify all other PINEs about this change and the PEMC's reachability information. The PEGC (300) has list of PIN elements which are in active state and connected to the PIN. In an embodiment, the PEGC (300) can fetch the PIN dynamic information containing the details of the PIN elements from PIN MS (100) or PEMC (200).

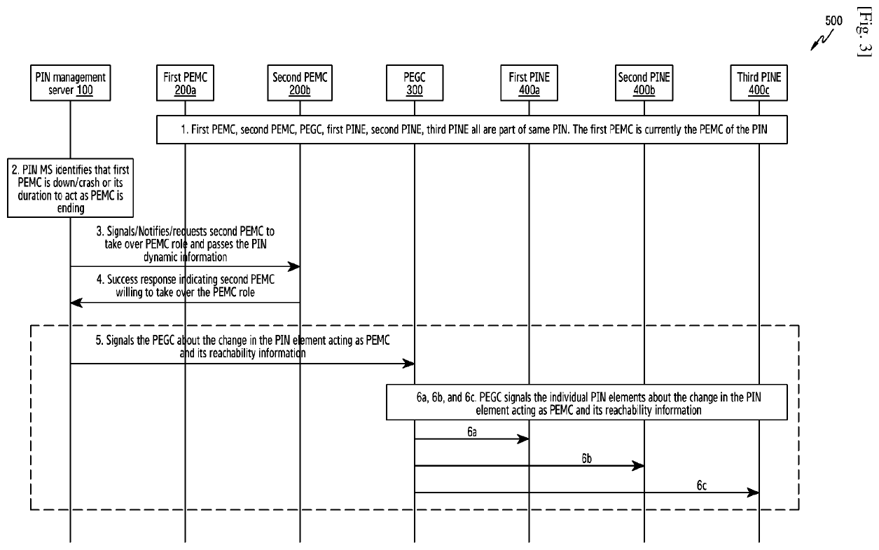

FIG. 4 depicts another approach for performing the PEMC switchover, according to the embodiments as disclosed herein. Consider that the dynamic information about the PIN (500) is available at the PIN management server (100).

Step 1: The first PEMC (200A), the second PEMC (200b), the PEGC (300), the first PINE (400a), the second PINE (400b), and the third PINE (400c) are part of same PIN (500). The first PEMC (200A) is currently the PEMC of the PIN (500).

Step 2: The PIN MS (100) identifies that the first PEMC (200A) is down/crash or its duration to act as the PEMC is ending.

Step 3: On identifying that the current PEMC down, the PIN MS (100) signals or notifies all the PIN elements currently active in the PIN (500) that the PEMC role is being changed and requests if any of the PIN elements can take the role of the PEMC.

Step 4: On getting the signal from the PIN MS (100), the second PEMC (200b) requests or notifies/signals the PIN MS (100) that it can act as PEMC. Multiple PIN elements may request the PIN MS (100) to take the role of PEMC and it is up-to the PIN MS (100) to decide which PIN element can be authorized to take the role of the PEMC.

Step 5: The PIN MS (100) determines whether the second PEMC (200b) can be authorized to take the role of PEMC

Step 6: If authorized, the PIN MS (100) sends the success response to the second PEMC (200b) to indicate that it is authorized to take the role of the PEMC.

Step 7: All the PIN elements in the PIN (500) are notified about the change in the PEMC and are provided with the details like PIN Element ID of the PEMC, PIN ID, and the reachability information of PEMC. The PIN elements can be notified in any of the following ways:

*a. The PIN MS (100) notifies the PEGC (300) about the change in the PEMC role and the PEGC (300) in turn notifies all the active PIN elements in the PIN about the change in the PEMC role and the corresponding information like the PINE ID of the PEMC, reachability information, duration of its role as PEMC etc., (or)

*b. The PIN MS (100) notifies the PEGC (300) about the change in the PEMC role and also notifies all the active PIN elements, notification to the individual PIN elements (without 3GPP access) are routed via the PEGC (300) since the PIN MS (100) cannot reach the PIN elements inside the PIN directly.

*c. The new PINE taking the role of PEMC notifies all the PIN elements including the PEGC (300) that it is taking the role of PEMC and its reachability information.

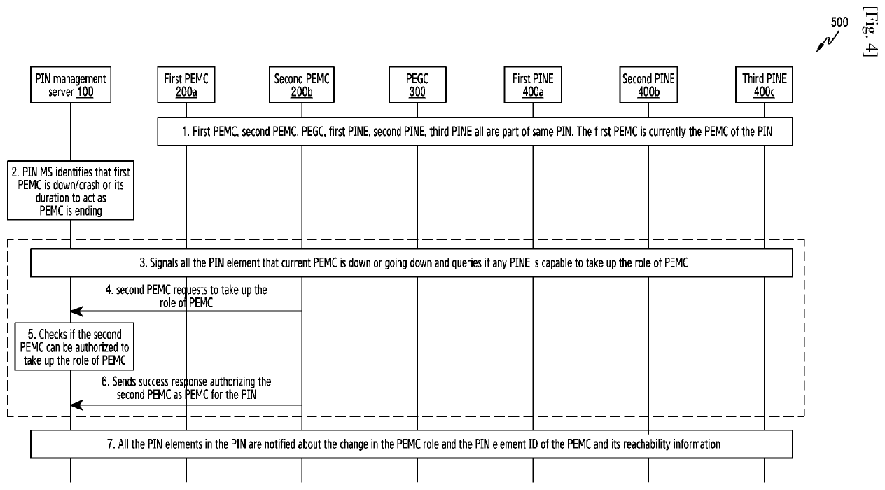

FIG. 5 depicts another approach for performing the PEMC switchover, according to the embodiments as disclosed herein. Consider that the second PEMC PIN element has indicated that it has the capability to anchor/act as PEMC for the PIN and this information is recorded in the PIN dynamic information, and the first PEMC (200A) proactively relinquishes and hands over the PEMC role to the other PIN element.

Step 1: The first PEMC (200A), the second PEMC (200b), the PEGC (300), the first PINE (400a), and the second PINE (400b) all are part of same PIN. The first PEMC (200A) is currently the PEMC of the PIN.

Step 2: The first PEMC (200A) decides to relinquish its PEMC role and handover to another PIN element. It may decide to do so, if it detects that its UE power is draining or its role as PEMC is nearing expiry.

Step 3: The first PEMC (200A) by looking into the PIN dynamic information, detects that the second PEMC (200b) is capable of taking up the PEMC role. The FIRST PEMC (200A) requests the second PEMC (200b) to take up the role of PEMC

Step 4: The second PEMC (200b) accepts to take up the role of the PEMC and sends a success response. After accepting the PEMC role, the second PEMC (200b) needs to retrieve the PIN profile information, PIN dynamic information and active profile information of each active PIN element, either from the PIN MS (100) or from the first PEMC (200a). Alternatively, this information can be pushed to the second PEMC (200b) by the first PEMC (200a) or the PIN MS (100).

Step 5: The first PEMC (200a) notifies the PIN MS (100) that it is relinquishing its role as the PEMC and the second PEMC (200b) is the new PEMC of the PIN. Notifying and releasing the role can be made as part of a single signal or the first PEMC (200a) can send separate signals for notifying and releasing.

Step 6: All the PIN elements in the PIN (500) are notified about the change in the PEMC and are provided with the details like PIN Element ID of the PEMC, PIN ID, and the reachability information of PEMC. The PIN elements can be notified in any of the following ways:

*a. The PIN MS (100) notifies the PEGC (300) about the change in the PEMC role and PEGC (300) in turn notifying all the active PIN elements in the PIN (500) about the change in the PEMC role and the corresponding information like PINE ID of the PEMC, reachability information, duration of its role as PEMC etc., (or)

*b. The PIN MS (100) notifies the PEGC (300) about the change in the PEMC role and also notifies all the active PIN elements, Notification to the individual PIN elements (without 3GPP access) are routed via the PEGC (300) since the PIN MS (100) cannot reach the PIN elements inside the PIN (500) directly.

*c. The new PINE taking the role of PEMC notifies all the PIN elements including the PEGC (300) that it is taking the role of PEMC and its reachability information.

*d. The PEMC which is currently relinquishing its role can notify all the PIN elements including the PEGC (300) that the second PEMC (200b) is the new PEMC and its reachability information.

FIG. 6 depicts another approach for performing the PEMC switchover, according to the embodiments as disclosed herein. Consider that the second PEMC PIN element has indicated that it has the capability to anchor/act as PEMC for the PIN (500) and this information is recorded in the PIN dynamic information, and the first PEMC (200a) proactively relinquishing and handing over the PEMC role to the other PIN element.

Step 1: The first PEMC (200a), the second PEMC (200b), the PEGC (300), the first PINE (400a), and the second PINE (400b) are part of same PIN. The first PEMC (200a) is currently the PEMC of the PIN.

Step 2: The first PEMC (200a) decides to relinquish its PEMC role and handover to another PIN element. It may decide this if it detects that its UE power is draining or its role as PEMC is nearing expiry.

Step 3: The first PEMC (200a) signals all the PIN elements that PEMC role is being changed and queries if any PINE is capable to take up the role of the PEMC. This signal contains the PIN ID, identifier of the first PEMC (200a) etc.

Step 4: The second PEMC (200b) on receiving the signal as in step-3 decides to take up the role of PEMC and sends the request to the first PEMC (200a) to indicate that it can take the role of the PEMC.

Step 5: The first PEMC (200a) checks the PIN information to verify whether the second PEMC (200b) can be authorized to take the role of PEMC or it can query the PIN MS (100) whether the second PEMC (200b) can be authorized to take the role of the PEMC.

Step 6: If the second PEMC (200b) is authorized, the first PEMC (200a) sends the success response to the second PEMC (200b). If the second PEMC (200b) does not send failure response and wait for requests from other PIN elements to take the role of PEMC and do not proceed with next steps. On receiving the success response, the second PEMC (200b) needs to retrieve the PIN profile information, PIN dynamic information and active profile information of each active PIN elements either from the PIN MS (100) or from the first PEMC (200a). Alternatively, this information can be pushed to the second PEMC (200b) by the first PEMC (200a) or PIN MS (100).

Step 7: The first PEMC (200a) notifies the PIN MS (100) that it is relinquishing its role as PEMC and the second PEMC (200b) is the new PEMC of the PIN. Notifying and releasing the role can be made as part of a single signal or the first PEMC (200a) can send separate signals for notifying and relcasing.

Step 8: All the PIN elements in the PIN are notified about the change in the PEMC and are provided with the details like PIN Element ID of the PEMC, PIN ID, and the reachability information of PEMC. The PIN elements can be notified in any of the following ways:

*a. The PIN MS (100) notifies the PEGC (300) about the change in the PEMC role and the PEGC (300) in turn notifying all the active PIN elements in the PIN about the change in the PEMC role and the corresponding information like PINE ID of the PEMC, reachability information, duration of its role as PEMC etc., (or)

*b. The PIN MS (100) notifies the PEGC (300) about the change in the PEMC role and also notifies all the active PIN elements, Notification to the individual PIN elements (without 3GPP access) are routed via the PEGC (300) since the PIN MS (100) cannot reach the PIN elements inside the PIN directly.

*c. The new PINE taking the role of PEMC notifies all the PIN elements including the PEGC (300) that it is taking the role of PEMC and its reachability information.

*d. The PEMC, which is currently relinquishing its role, can notify all the PIN elements including the PEGC (300) that the second PEMC (200b) is the new PEMC and its reachability information.

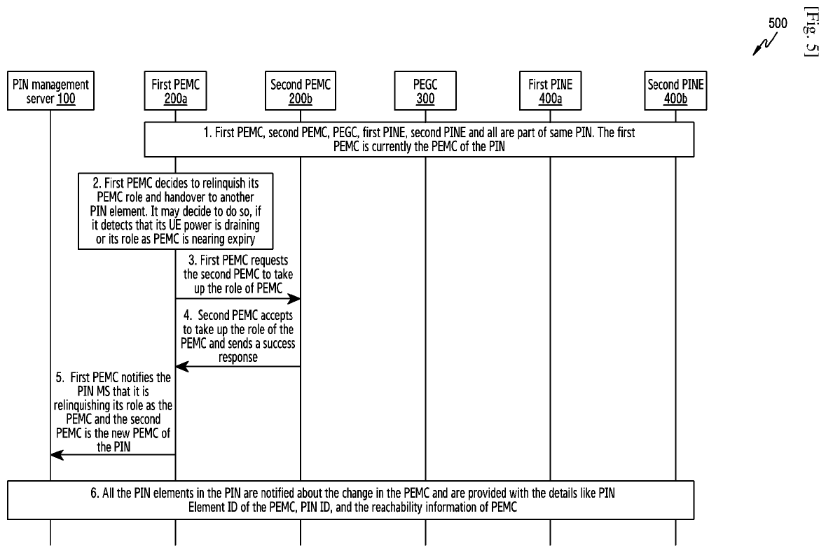

FIG. 7 shows various hardware components of the PIN management server (100), according to the embodiments as disclosed herein. In an embodiment, the PIN management server (100) includes a processor (110), a communicator (120), a memory (130) and a PEMC controller (140). The processor (110) is coupled with the communicator (120), the memory (130) and the PEMC controller (140).

The PEMC controller (140) detects the at least one event at the first PEMC entity (200a). The at least one event can be, for example, but not limited to the power of the first PEMC entity (200a) about to drain, the damage to the first PEMC entity (200a), and the role of the first PEMC entity (200a) nearing expiry. Upon detecting the at least one event at the first PEMC entity (200a), the PEMC controller (140) sends the request message to the second PEMC entity (200b) to transfer the PEMC role to the second PEMC entity (200b), where the PEMC role is currently associated with the first PEMC entity (200a). The request message includes the PIN dynamic information. In an embodiment, the PEMC controller (140) monitors the PIN dynamic information and the PIN profile associated with a plurality of second PEMC entities. Based on the PIN dynamic information and the PIN profile, the PEMC controller (140) detects that the second PEMC entity (200b) from the plurality of second PEMC entities is capable of taking up the PEMC role. Further, the PEMC controller (140) sends the request message to the second PEMC entity (200b) from the plurality of second PEMC entities to transfer the PEMC role to the second PEMC entity (200b). Based on the request message, the PEMC controller (140) receives the accept message from the second PEMC entity (200b) to transfer the PEMC role associated with the first PEMC entity (200a).

The PEMC controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 7 shows various hardware components of the PIN management server (100) but it is to be understood that other embodiments are not limited thereon. In other embodiments, the PIN management server (100) may include less or more number of components. Further, the labels or names of the components are used only for illustrative purpose and does not limit the scope of the invention. One or more components can be combined together to perform same or substantially similar function in the PIN management server (100).

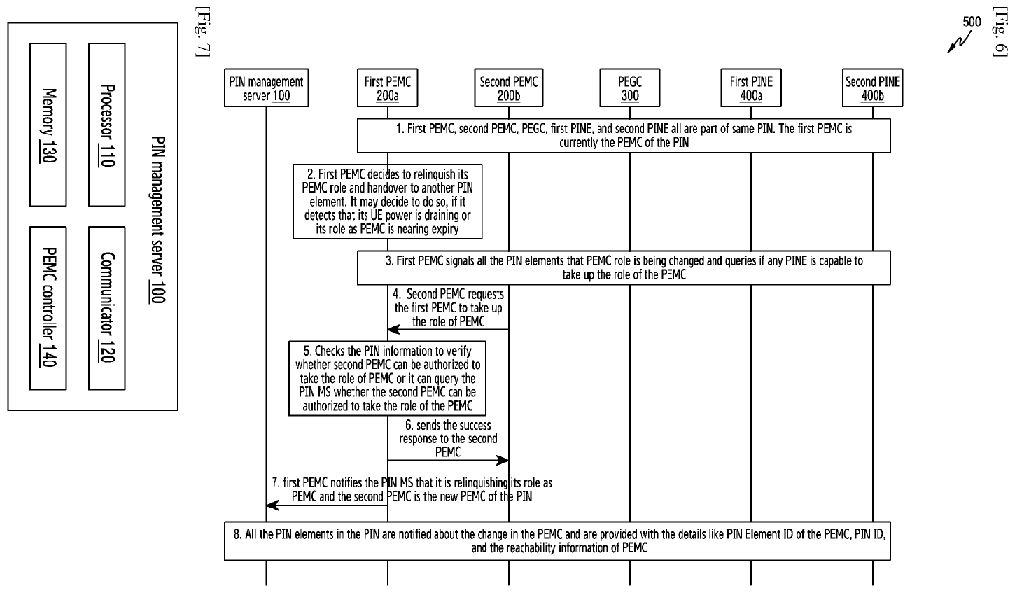

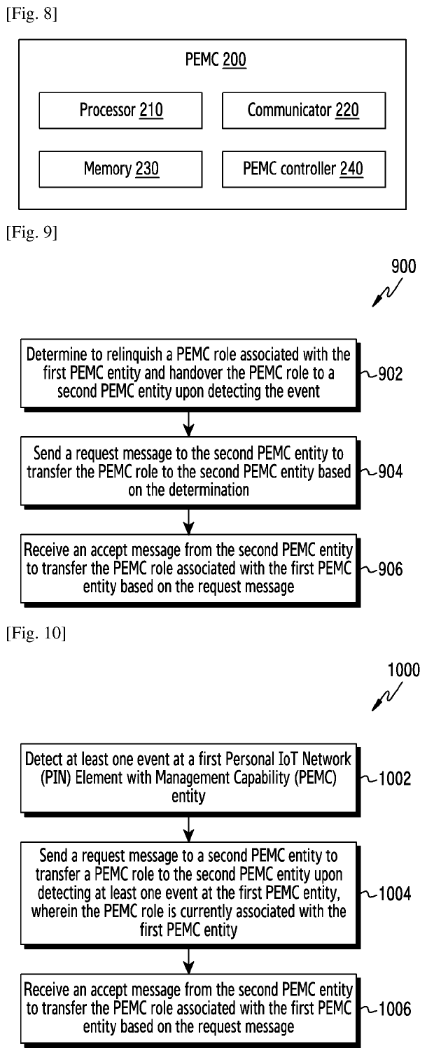

FIG. 8 shows various hardware components of the PEMC entity or PEMC (200), according to the embodiments as disclosed herein. In an embodiment, the PEMC (200) includes a processor (210), a communicator (220), a memory (230) and a PEMC controller (240). The processor (210) is coupled with the communicator (220), the memory (230) and the PEMC controller (240).

The PEMC controller (240) determines to relinquish the PEMC role associated with the first PEMC entity (200a) and handovers the PEMC role to the second PEMC entity (200b) upon detecting at least one event. The at least one event can be, for example, but not limited to the power of the first PEMC entity (200a) about to drain and the role of the first PEMC entity (200a) nearing expiry. Based on the determination, the PEMC controller (240) sends the request message to the second PEMC entity (200b) to transfer the PEMC role to the second PEMC entity (200b). In an embodiment, the PEMC controller (240) monitors the PIN dynamic information associated with the plurality of second PEMC entities (200b). Based on the PIN dynamic information, the PEMC controller (240) detects that the second PEMC entity (200b) from the plurality of second PEMC entities is capable of taking up the PEMC role. Further, the PEMC controller (240) sends the request message to the second PEMC entity (200b) from the plurality of second PEMC entities to transfer the PEMC role to the second PEMC entity (200b). Based on the request message, the PEMC controller (240) receives the accept message from the second PEMC entity (200b) to transfer the PEMC role associated with the first PEMC entity (200a).

In an embodiment, the PEMC controller (240) notifies the PIN management server (100) about the transfer of the PEMC role associated with the first PEMC entity (200a) to the second PEMC entity (200b). Further, the PEMC controller (240) releases the transfer of the PEMC role associated with the first PEMC entity (200a) to the second PEMC entity (200b).

In another embodiment, the PEMC controller (240) sends at least one of the PIN profile information, the PIN dynamic information and the active profile information of each active PIN element through at least one of the first PEMC entity (200a) and the PIN management server (100).

The PEMC controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 8 shows various hardware components of the PEMC (200) but it is to be understood that other embodiments are not limited thereon. In other embodiments, the PEMC (200) may include less or more number of components. Further, the labels or names of the components are used only for illustrative purpose and does not limit the scope of the invention. One or more components can be combined together to perform same or substantially similar function in the PEMC (200).

FIG. 9 is a flow chart (900) illustrating a method, implemented by the PEMC entity (200), for managing the PEMC switchover in the PIN (500), according to the embodiments as disclosed herein. The operations (902-906) are handled by the PEMC controller (240).

At 902, the method includes determining to relinquish the PEMC role associated with the first PEMC entity (200a) and handover the PEMC role to the second PEMC entity (200b) upon detecting the at least one event. At 904, the method includes sending the request message to the second PEMC entity (200b) to transfer the PEMC role to the second PEMC entity (200b) based on the determination. At 906, the method includes receiving the accept message from the second PEMC entity (200b) to transfer the PEMC role associated with the first PEMC entity (200a) based on the request message.

FIG. 10 is a flow chart (1000) illustrating a method, implemented by the PIN management server (100), for managing the PEMC switchover in the PIN (500), according to the embodiments as disclosed herein. The operations (1002-1006) are handled by the PEMC controller (140).

At S1002, the method includes detecting the at least one event at the first PEMC entity (200a). At S1004, the method includes sending the request message to the second PEMC entity (200b) to transfer the PEMC role to the second PEMC entity (200b) upon detecting at least one event at the first PEMC entity (200a). The PEMC role is currently associated with the first PEMC entity (200a). At S1006, the method includes receiving the accept message from the second PEMC entity (200b) to transfer the PEMC role associated with the first PEMC entity (200a) based on the request message.

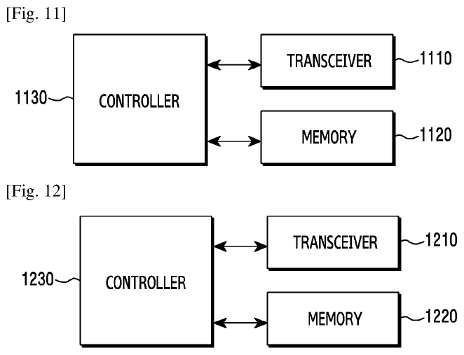

FIG. 11 illustrates a block diagram of a server (e.g., PIN server) according to embodiments of the present disclosure.

As shown in FIG. 11, a server according to an embodiment may include a transceiver 1110, a memory 1120, and a controller 1130. The transceiver 1110, the memory 1120, and the controller 1130 of the server may operate according to a communication method of the server described above. However, the components of the server are not limited thereto. For example, the server may include more or fewer components than those described in FIG. 11. In addition, the controller 1130, the transceiver 1110, and the memory 1120 may be implemented as a single chip. Also, the controller 1130 may include at least one processor.

The transceiver 1110 collectively refers to a server receiver and a server transmitter, and may transmit/receive a signal to/from other network entities (or network functions or network nodes). The signal transmitted or received to or from the server may include control information and data.

Also, the transceiver 1110 may receive and output, to the controller 1130, a signal through a wireless or a wired channel, and transmit a signal output from the controller 1130 through the wireless or the wired channel.

The memory 1120 may store a program and data required for operations of the server. Also, the memory 1120 may store control information or data included in a signal obtained by the server. The memory 1120 may be a storage medium, such as read-only memory (ROM), random access memory (RAM), a hard disk, a CD-ROM, and a DVD, or a combination of storage media.

The controller 1130 may control a series of processes such that the server operates as described above.

FIG. 12 illustrates a block diagram of a network entity (e.g., PEMC, PEGC, PINE, etc.) according to embodiments of the present disclosure.

As shown in FIG. 12 is, the network entity of the present disclosure may include a transceiver 1210, a memory 1220, and a controller 1230. The transceiver 1210, the memory 1220, and the controller 1230 of the network entity may operate according to a communication method of the network entity described above. However, the components of the network entity are not limited thereto. For example, the network entity may include more or fewer components than those described in FIG. 12. In addition, the controller 1230, the transceiver 1210, and the memory 1220 may be implemented as a single chip. Also, the controller 1230 may include at least one processor.

The transceiver 1210 collectively refers to a network entity receiver and a network entity transmitter, and may transmit/receive a signal to/from other network entities (or network functions, network nodes, or server). The signal transmitted or received to or from the network entity may include control information and data.

Also, the transceiver 1210 may receive and output, to the controller 1230, a signal through a wireless or a wired channel, and transmit a signal output from the controller 1230 through the wireless or the wired channel.

The memory 1220 may store a program and data required for operations of the network entity. Also, the memory 1220 may store control information or data included in a signal obtained by the network entity. The memory 1220 may be a storage medium, such as ROM, RAM, a hard disk, a CD-ROM, and a DVD, or a combination of storage media.

The controller 1230 may control a series of processes such that the network entity operates as described above.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the afore-described embodiments of the present disclosure, elements included in the present disclosure are expressed in a singular or plural form according to the embodiments. However, the singular or plural form is appropriately selected for con-venience of explanation and the present disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various actions, acts, blocks, steps, or the like in the flow charts (900 and 1000) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method performed by a first personal internet of things network (PIN) element with management capability (PEMC) entity, which is a PEMC of a PIN, in a wireless communication system, the method comprising:
identifying to relinquish a PEMC role based on a condition being satisfied;
transmitting, to a second PEMC entity which has a capability for the PEMC of the PIN, a request message to take up the PEMC role;
receiving, from the second PEMC entity, a success response message for the request message; and
transmitting, to the second PEMC entity, PIN profile information for the PEMC role.

2. The method of claim 1, further comprising:
transmitting a message for notifying that the first PEMC entity is relinquishing the PEMC role and the second PEMC entity is a new PEMC of the PIN, to each of a PIN server, a PIN element gateway capability (PEGC) entity, and at least one PIN element (PINE).

3. The method of claim 2, wherein the message comprises reachability information of the new PEMC of the PIN.

4. The method of claim 1, wherein the condition includes a power draining or an expiry of a duration of the PEMC role.

5. A method performed by a second personal internet of things network (PIN) element with management capability (PEMC) entity, which has a capability for a PEMC of a PIN, in a wireless communication system, the method comprising:
receiving, from a first PEMC entity which is the PEMC of the PIN, a request message to take up a PEMC role, based on a condition being satisfied;
transmitting, to the first PEMC entity, a success response message for the request message; and
receiving, from the first PEMC entity, PIN profile information for the PEMC role.

6. The method of claim 5, wherein a message for notifying that the first PEMC entity is relinquishing the PEMC role and the second PEMC entity is a new PEMC of the PIN is transmitted, to each of a PIN server, a PIN element gateway capability (PEGC) entity, and at least one PIN element (PINE), and
wherein the message comprises reachability information of the new PEMC of the PIN.

7. The method of claim 5, wherein the condition includes a power draining or an expiry of a duration of the PEMC role.

8. A first personal internet of things network (PIN) element with management capability (PEMC) entity, which is a PEMC of a PIN, in a wireless communication system, the first PEMC entity comprising:
a transceiver; and
a controller coupled with the transceiver and configured to:
identify to relinquish a PEMC role based on a condition being satisfied, transmit, to a second PEMC entity which has a capability for the PEMC of the PIN, a request message to take up the PEMC role,
receive, from the second PEMC entity, a success response message for the request message, and
transmit, to the second PEMC entity, PIN profile information for the PEMC role.

9. The first PEMC entity of claim 8, wherein the controller is further configured to:
transmit a message for notifying that the first PEMC entity is relinquishing the PEMC role and the second PEMC entity is a new PEMC of the PIN, to each of a PIN server, a PIN element gateway capability (PEGC) entity, and at least one PIN element (PINE).

10. The first PEMC entity of claim 9, wherein the message comprises reachability information of the new PEMC of the PIN.

11. The first PEMC entity of claim 8, wherein the condition includes a power draining or an expiry of a duration of the PEMC role.

12. A second personal internet of things network (PIN) element with management capability (PEMC) entity, which has a capability for a PEMC of a PIN, in a wireless communication system, the second PEMC entity comprising:
a transceiver; and
a controller coupled with the transceiver and configured to:
receive, from a first PEMC entity which is the PEMC of the PIN, a request message to take up a PEMC role, based on a condition being satisfied,
transmit, to the first PEMC entity, a success response message for the request message, and
receive, from the first PEMC entity, PIN profile information for the PEMC role.

13. The second PEMC entity of claim 12, wherein a message for notifying that the first PEMC entity is relinquishing the PEMC role and the second PEMC entity is a new PEMC of the PIN is transmitted, to each of a PIN server, a PIN element gateway capability (PEGC) entity, and at least one PIN element (PINE).

14. The second PEMC entity of claim 13, wherein the message comprises reachability information of the new PEMC of the PIN.

15. The second PEMC entity of claim 12, wherein the condition includes a power draining or an expiry of a duration of the PEMC role.
